(19) United States
(12) Patent Application Publication
(10) Pub. No.: US 2024/0359496 A1
(43) Pub. Date: Oct. 31, 2024

(54) IMAGE FORMING APPARATUS

(71) Applicant: KYOCERA Document Solutions Inc., Osaka (JP)

(72) Inventor: Takuya Hamada, Osaka (JP)

(21) Appl. No.: 18/646,636

(22) Filed: Apr. 25, 2024

(30) Foreign Application Priority Data
Apr. 26, 2023 (JP) 2023-072324

(51) Int. Cl. B41J 29/46; B41J 11/00; B41J 29/12; B41J 29/377

(52) U.S. Cl. CPC B41J 29/46; B41J 11/0022; B41J 29/12; B41J 29/377

(57) ABSTRACT

An image forming apparatus includes: an image forming portion which discharges ink onto a recording medium to form an image; a heat source portion which heats the ink on the recording medium; an exhaust air duct from which gas heated by the heat source portion is exhausted; and a detection portion which detects smoke or gas generated at a time of fire. The exhaust air duct is arranged such that an inlet from which gas is sucked in opposes the heat source portion. The detection portion is arranged inside the exhaust air duct.

### INCORPORATION BY REFERENCE

This application is based upon and claims the benefit of priority from the corresponding Japanese Patent Application No. 2023-072324 filed on Apr. 26, 2023, the entire contents of which are incorporated herein by reference.

### BACKGROUND

The present disclosure relates to an image forming apparatus.

There is known an image forming apparatus including a smoke sensor for detecting fire of a recording medium or driving component housed inside the apparatus.

Smoke is accumulated inside the apparatus at an upper portion thereof. For example, there is known a jam detection apparatus in which a duct for collecting smoke is provided on a top surface inside the apparatus, and a sensor which detects smoke is provided in that duct.

There is also known a printing apparatus in which a suction port for collecting smoke is provided on a conveying path of a recording medium, and a sensor which detects smoke is provided in that suction port.

In the two examples of the jam detection apparatus and the printing apparatus, a dedicated smoke flow path (the duct, the suction port) needs to be provided for detecting smoke. In addition, in the two examples described above, a fan needs to be installed for causing smoke to flow into the dedicated smoke flow path. As a result, there has been a problem that sizes and costs of the apparatuses increase in the two examples described above.

Moreover, in each of the two examples described above, detection of smoke is performed after a recording medium is conveyed to a position set apart from a heat source (a heater lamp, an infrared heater) that is to be a cause of the fire. Consequently, there has been a problem that detection of smoke will be late or that even when the recording medium positioned right below the heat source catches fire at a time of an anomaly (jam), such a state cannot be detected immediately.

### SUMMARY

An image forming apparatus according to the present disclosure includes: an image forming portion which discharges ink onto a recording medium to form an image; a heat source portion which heats the ink on the recording medium; an exhaust air duct from which gas heated by the heat source portion is exhausted; and a detection portion which detects smoke or gas generated at a time of fire. The exhaust air duct is arranged such that an inlet from which gas is sucked in opposes the heat source portion. The detection portion is arranged inside the exhaust air duct.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing an example of a configuration of an image forming apparatus according to an embodiment of the present disclosure; and

FIG. 2 is a diagram showing a detailed configuration of a drying portion of the image forming apparatus shown in FIG. 1.

### DETAILED DESCRIPTION

Hereinafter, an embodiment of the present disclosure will be described with reference to the drawings. It is noted that in the figures, the same or corresponding portions are denoted by the same reference numerals, and descriptions will not be repeated.

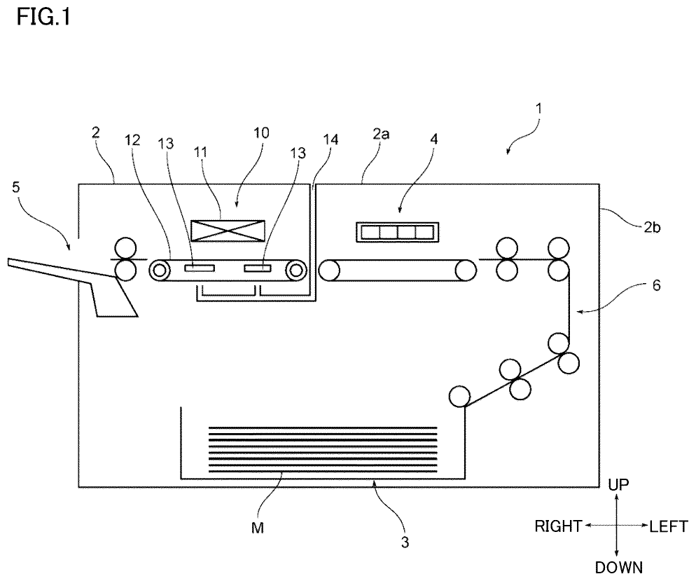

First, a configuration of an image forming apparatus 1 according to the present embodiment will be described with reference to FIG. 1. FIG. 1 is a diagram showing an example of the configuration of the image forming apparatus 1 according to the present embodiment.

The image forming apparatus 1 is an apparatus which forms an image on a recording medium M. As shown in FIG. 1, the image forming apparatus 1 includes an apparatus housing 2, a feeding portion 3, an image forming portion 4 that uses an inkjet recording system, a drying portion 10, a discharge portion 5, a conveying portion 6, and a control portion (not shown).

The feeding portion 3 picks up the recording medium M stored inside the apparatus housing 2 and supplies the recording medium M to the conveying portion 6. Inside the apparatus housing 2, the conveying portion 6 conveys the recording medium M from the feeding portion 3 to the discharge portion 5 via the image forming portion 4 and the drying portion 10.

The image forming portion 4 discharges ink onto the recording medium M to form an image. The drying portion 10 dries the ink on the recording medium M. The discharge portion 5 discharges the recording medium M on which an image has been formed by the image forming portion 4 to outside the apparatus housing 2. The control portion controls operations of the image forming apparatus 1.

The feeding portion 3, the image forming portion 4, the discharge portion 5, and the conveying portion 6 have configurations similar to those of a feeding portion, an image forming portion that uses the inkjet recording system, a discharge portion, and a conveying portion that are applied to a well-known image forming apparatus. Various materials such as paper, textile, synthetic paper, a polyvinyl chloride sheet, tarpaulin, and cloth are used as the recording medium M.

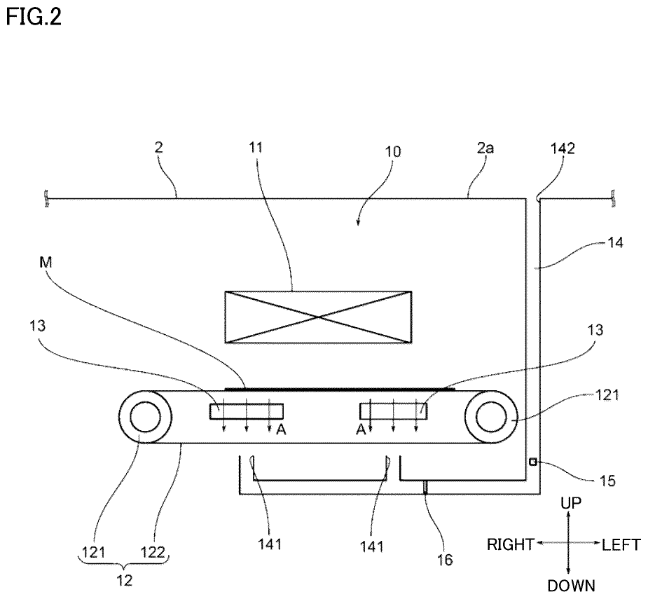

Next, a detailed configuration of the drying portion 10 will be described with reference to FIG. 1 and FIG. 2. FIG. 2 is a diagram showing the detailed configuration of the drying portion 10 of the image forming apparatus 1 according to the present embodiment.

In descriptions below, as shown in FIG. 1 and FIG. 2, a vertical direction in a state where the image forming apparatus 1 is installed in a usable state is defined as an up-down direction, and a left-right direction is defined while a side on which the discharge portion 5 is provided is defined as a right side. A direction orthogonal to the up-down direction and the left-right direction is defined as a front-rear direction.

The drying portion 10 is arranged on a downstream side of the image forming portion 4 in a conveying direction of the recording medium M. The drying portion 10 heats ink discharged onto the recording medium M in the image forming portion 4 only for a certain time to thus dry the ink on the recording medium M.

The drying portion 10 includes a heat source portion 11, a conveying belt 12, medium suction fans 13, an exhaust air duct 14, and a detection portion 15. The drying portion 10 may further include a dust removal filter 16.

The heat source portion 11 heats the ink on the recording medium M. The heat source portion 11 is, for example, an infrared heater or the like. The heat source portion 11 heats the ink on the recording medium M conveyed by the conveying belt 12 to thus dry the ink on the recording medium M.

The conveying belt 12 includes a pair of rollers 121 constituted of a drive roller and a driven roller and a belt 122 provided across the pair of rollers 121. The pair of rollers 121 each include a rotation shaft extending in a direction orthogonal to the conveying direction (the left-right direction) of the recording medium M (the front-rear direction). The rotation shafts of the pair of rollers 121 are arranged while being set apart from each other in the conveying direction of the recording medium M.

The belt 122 is endless and is stretched to enclose the pair of rollers 121. In the conveying belt 12, the pair of rollers 121 are driven so that the belt 122 moves in the conveying direction (a right-hand direction) or an opposite direction from the conveying direction (a left-hand direction). A plurality of through-holes (not shown) that penetrate the belt 122 in a thickness direction are formed in the belt 122.

The medium suction fans 13 are arranged inside the endless belt 122 of the conveying belt 12. By being driven, the medium suction fans 13 suck the recording medium M placed on an upper surface of the belt 122 to the belt 122.

In other words, the medium suction fans 13 are driven to generate a negative pressure inside the medium suction fans 13. The medium suction fans 13 cause the recording medium M on the upper surface of the belt 122 to be sucked to the belt 122 via the plurality of through-holes provided in the belt 122. Thus, by the belt 122 moving by the drive of the rollers 121, the recording medium M on the belt 122 is conveyed.

The exhaust air duct 14 exhausts gas heated by the heat source portion 11. The exhaust air duct 14 includes inlets 141 for sucking in gas and an outlet 142 for exhausting gas. The exhaust air duct 14 is arranged so as to extend from a position opposing the heat source portion 11 to an upper surface 2a of the apparatus housing 2 or a side surface 2b of the apparatus housing 2 in the front-rear or left-right direction.

Specifically, the exhaust air duct 14 is arranged such that the inlets 141 oppose the heat source portion 11. In other words, the inlets 141 of the exhaust air duct 14 are arranged on a downstream side of (below) the medium suction fans 13. The outlet 142 of the exhaust air duct 14 is formed on the upper surface 2a of the apparatus housing 2 or the side surface 2b of the apparatus housing 2 in the front-rear or left-right direction.

The dust removal filter 16 removes dust generated from the recording medium M. The dust removal filter 16 is arranged inside the exhaust air duct 14. The dust removal filter 16 is a well-known arbitrary filter capable of removing dust such as paper dust generated from the recording medium M.

The detection portion 15 is a sensor which detects smoke or gas generated at the time of fire. The detection portion 15 is arranged inside the exhaust air duct 14. It is favorable for the detection portion 15 to be arranged inside the exhaust air duct 14 at a position at which an effect of contamination of dust generated from the recording medium M is small.

For example, the detection portion 15 is arranged at the downstream of the dust removal filter 16 or, when the exhaust air duct 14 is bent or curved, the downstream of the bent or curved portion of the exhaust air duct 14. A well-known arbitrary smoke sensor capable of detecting smoke or gas, a firedamp alarm, or the like is used as the detection portion 15.

The detection portion 15 is turned ON/OFF in an interlocking manner with ON/OFF of a power supply of the heat source portion 11. Specifically, when the recording medium M is conveyed to the drying portion 10 and the power supply of the heat source portion 11 is turned ON, a power supply of the detection portion 15 is also turned ON. When drying of the ink on the recording medium M is ended and the power supply of the heat source portion 11 is turned OFF, the power supply of the detection portion 15 is also turned OFF.

This switch between ON/OFF of the power supply of each of the heat source portion 11 and the detection portion 15 is performed by the control portion provided in the image forming apparatus 1. It is noted that the detection portion 15 may be constantly ON so as to be capable of constantly detecting smoke or gas.

In the image forming apparatus 1, ink on the recording medium M is heated and dried by the heat source portion 11. In such an image forming apparatus 1, when the heat source portion 11 heats the ink on the recording medium M, an anomaly such as generation of smoke or catching of fire may occur.

In the image forming apparatus 1 according to the present embodiment, when the anomaly such as generation of smoke or catching of fire occurs, smoke and/or gas generated by the anomaly flow(s) into the exhaust air duct 14 from the inlets 141.

In other words, for the medium suction fans 13 to cause the recording medium M to be sucked to the conveying belt 12, the medium suction fans 13 cause an airflow A that flows downwardly from above as indicated by the arrows in FIG. 2. With this airflow A, the smoke and/or gas flow(s) into the exhaust air duct 14 from the inlets 141.

As the smoke and/or gas flow(s) into the exhaust air duct 14, the smoke and/or gas are/is detected by the detection portion 15 arranged inside the exhaust air duct 14.

As described heretofore, in the image forming apparatus 1 according to the present disclosure, the detection portion 15 is arranged inside the exhaust air duct 14 in which the inlets 141 are provided opposed to the heat source portion 11 where generation of smoke and catching of fire are most apt to occur inside the apparatus. Thus, if an anomaly occurs and smoke and gas are generated, the smoke and gas flow into the exhaust air duct 14 immediately after the occurrence to be immediately detected by the detection portion 15 arranged in the exhaust air duct 14.

In general, airflows of smoke and gas are quick while the movement of the recording medium M that needs to be dried for a certain time is slow. Therefore, in the present disclosure, it is possible to readily detect an anomaly such as the generation of smoke and gas as compared to a conventional configuration in which the detection portion detects an anomaly after the recording medium is moved to a position set apart from the heat source portion 11.

In addition, the image forming apparatus 1 according to the present disclosure uses the existing exhaust air duct 14 provided in the drying portion 10, and the detection portion 15 which detects smoke and gas is provided inside the exhaust air duct 14.

Since smoke and gas are detected by the detection portion 15 arranged inside the exhaust air duct 14 as described above, there is no need to newly provide a flow path for detecting smoke and gas. In addition, there is no need to install a fan or the like to cause the smoke and gas to flow into that flow path. Thus, an anomaly such as the generation of smoke and gas can be detected without increasing the size of the apparatus.

Heretofore, the embodiment of the present disclosure has been described with reference to the drawings. It is noted that the present disclosure is not limited to the embodiment described above and can be variously modified without departing from the gist of the present disclosure.

In addition, the plurality of constituent elements disclosed in the embodiment described above can be combined as appropriate to form various disclosures.

For example, some constituent elements may be deleted from all of the constituent elements disclosed in the embodiment. In the drawings, the respective constituent elements may be schematically illustrated to help understand the present disclosure. The thickness, length, number, and the like of the respective constituent elements shown in the figures may differ from the actual thickness, length, number, and the like for convenience in creating the drawings.

Further, the shape, size, and the like of the respective constituent elements described in the embodiment above are mere examples that are not limited in particular, and may be variously modified substantially without departing from the configuration of the present disclosure.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus, comprising:
an image forming portion which discharges ink onto a recording medium to form an image;
a heat source portion which heats the ink on the recording medium;
an exhaust air duct from which gas heated by the heat source portion is exhausted; and
a detection portion which detects smoke or gas generated at a time of fire, wherein
the exhaust air duct is arranged such that an inlet from which gas is sucked in opposes the heat source portion, and
the detection portion is arranged inside the exhaust air duct.

2. The image forming apparatus according to claim 1, wherein
the detection portion is arranged inside the exhaust air duct at a position at which an effect of contamination of dust generated from the recording medium is small.

3. The image forming apparatus according to claim 2, further comprising:
a dust removal filter which removes dust generated from the recording medium, wherein
the dust removal filter is arranged inside the exhaust air duct, and
the detection portion is arranged on a downstream side of the dust removal filter.
